(19) United States
(12) Patent Application Publication
(10) Pub. No.: US 2010/0243376 A1
(43) Pub. Date: Sep. 30, 2010

(54) Lubricant fill and drain assembly for a gearbox

(76) Inventor: Ricky D. McGee, Gretna, NE (US)

Correspondence Address: THOMTE LAW OFFICE, L.L.C., 2120 S. 72ND STREET, SUITE 1111, OMAHA, NE, 68124, US

(21) Appl. No.: 12/384,026

(22) Filed: Mar. 31, 2009

(51) Int. Cl. F16H 57/04

(52) U.S. Cl. 184/6.12

(57) ABSTRACT

A lubricant fill and drain assembly for a gearbox mounted on a drive unit of a mechanized irrigation system is disclosed which provides a convenient means for adding lubricant to a gearbox and for draining lubricant and/or water from the gearbox from a position somewhat remote from the gearbox. The assembly of this invention not only provides a convenient way of adding lubricant to the gearbox but ensures that the gearbox will not be over filled with lubricant.

### BACKGROUND OF THE INVENTION

1. Field of the Invention

This invention relates to a lubricant fill and drain assembly for a gearbox and more particularly to a lubricant fill and drain for a gearbox mounted on a drive unit of a mechanized irrigation system.

2. Description of the Related Art

Mechanized irrigation systems such as center pivot irrigation systems, linear move irrigation systems, and corner systems utilize a plurality of drive units which support a water pipeline and move the same through the field to be irrigated. In most mechanized irrigation systems, a pair of drive wheels are mounted on each of the drive units or drive towers with each of the drive wheels being driven by a gearbox which in turn is driven by an electric motor. Normally, the gearboxes are located closely adjacent the wheels of the drive units which makes it difficult to drain lubricant or water from the gearbox when necessary or to fill the gearbox with lubricant when necessary. If the lubricant level is too low within the gearbox, damage may occur to the gears therein. If the gearbox is overly filled with lubricant, thereby reducing the necessary air volume within the upper end of the gearbox, the reduced air volume may cause increased pressure inside the gearbox and force lubricant through the seals of the gearbox thereby creating a leak.

Prior to the instant invention, the filling of the gearbox with lubricant required the use of long funnels or hoses to direct the flow of lubricant to a location having limited access because of the drive wheel position closely adjacent thereto. The fill holes on some gearboxes are vertically mounted and difficult to fill using common equipment. Further, the fill holes of the gearboxes are often covered by soil and must be cleaned prior to gaining access thereto in order to avoid contamination of the lubricant. The drain hole on the gearboxes is difficult to reach and is difficult to provide a means to control the flow of lubricant therefrom when the lubricant is being changed or when water is being drained from the interior of the gearbox.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A lubricant fill and drain assembly for a gearbox mounted on a drive unit of a mechanized irrigation system is described with the gearbox having upper and lower ends. A lubricant fill hole extends into the gearbox below the upper end thereof and a lubricant drain hole is formed in the lower end of the gearbox. When the assembly of this invention is to be installed on a gearbox, the drain plug is removed from the lower end of the gearbox and a fitting is mounted in the drain hole of the gearbox. A first pipe has one end thereof secured to the fitting in the drain hole and the other end thereof is secured to a valve which is located remotely of the gearbox. The valve includes a valve body having a valve rotatably mounted therein. The valve body has a first opening which is in communication with a first pipe, a drain opening and a second opening. The interior of the valve body has a horizontally disposed cylindrical chamber formed therein in which a rotary valve is positioned.

An upstanding second pipe is secured to the second opening of the valve body and extends upwardly therefrom to a height which is substantially level with the fill opening in the gearbox. When the valve is rotated to a first position, the lower end of the second pipe is in fluid communication with the first pipe so that lubricant may flow through the valve to enable it to be added to the interior of the gearbox. When the valve is rotated to a second position, the first pipe is in communication with the drain opening in the valve so that water or lubricant may be drained from the gearbox. In a position between the first and second positions, the lubricant is prevented from passing through the valve.

When it is desired to fill the gearbox with lubricant, the oversized cap at the upper end of the second pipe is removed. Lubricant is then funneled or poured into the second pipe and the level of the lubricant in the gearbox will reach the same height and no greater than the height of the lubricant in the second pipe thereby preventing overfilling of the gearbox. When it is desired to drain water or lubricant from the interior of the gearbox, the valve is rotated to its second position so that the lubricant or water from the gearbox may drain outwardly from the drain opening in the valve. When the gearbox is either being filled or drained, the valve is rotated to its second position.

The assembly of this invention ensures that the gearbox will not be overfilled with lubricant thereby preventing undue pressure being created within the gearbox. The remote location of the upper end of the second pipe from the gearbox makes it convenient to fill the gearbox with lubricant. Further, the remote location of the valve from the gearbox provides a convenient way to either drain water or lubricant from the gearbox or to add lubricant to the gearbox.

It is therefore a principal object of the invention to provide a lubricant fill and drain assembly for a gearbox mounted on a drive unit of a mechanized irrigation system.

A further object of the invention is to provide a lubricant fill and drain assembly for a gearbox mounted on a drive unit of a mechanized irrigation system which provides a convenient means for either adding lubricant to the gearbox or draining lubricant and/or water from the gearbox.

Still another object of the invention is to provide a lubricant fill and drain assembly for a gearbox mounted on a drive unit of a mechanized irrigation system which ensures that the gearbox will not be over filled with lubricant.

Still another object of the invention is to provide a lubricant fill and drain assembly for a gearbox mounted on a drive unit of a mechanized irrigation system which may be conveniently and easily attached to the gearbox without modification thereof.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view illustrating a typical mechanized irrigation system including drive units which employ gearboxes thereon;

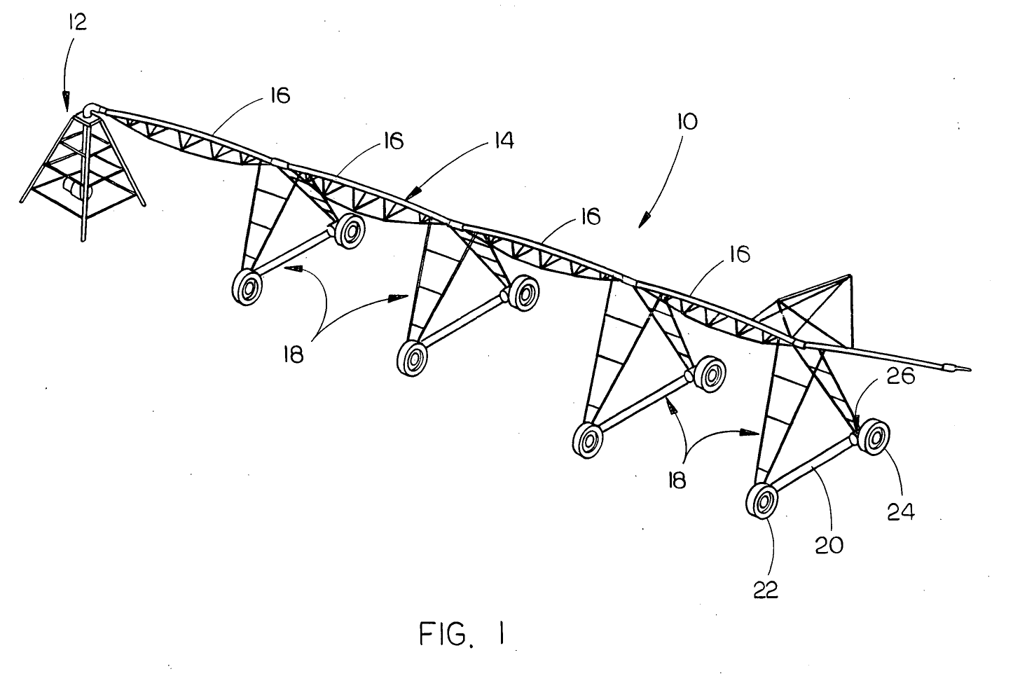

FIG. 2 is a partial perspective view of the irrigation system illustrating the portion of the drive unit and the associated gearbox having the lubricant fill and drain assembly of this invention secured to the gearbox;

FIG. 3 is a partial side view of the assembly of this invention with portions thereof cutaway to more fully illustrate the invention; and

FIG. 4 is a perspective view of the assembly of this invention.

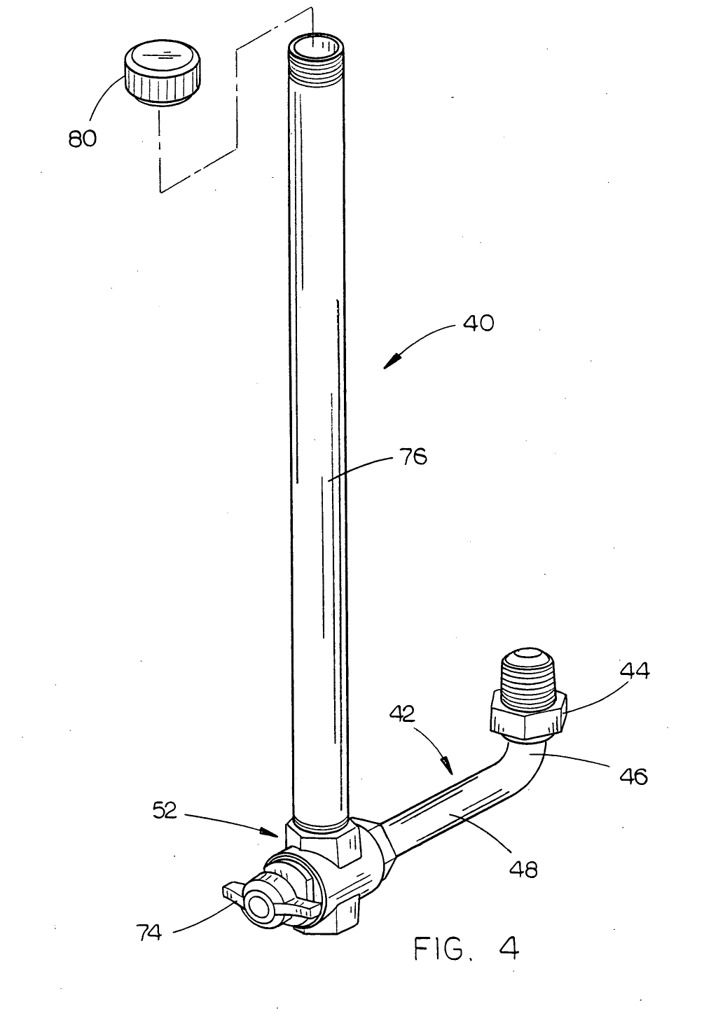

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers generally to a mechanized irrigation system such as a center pivot irrigation system. The system 10 conventionally includes a center pivot structure 12 having a main water pipeline 14 extending outwardly therefrom. Pipeline 16 includes a plurality of sprinklers mounted thereon (not shown). The pipeline 14 includes a plurality of span structures which are supported upon drive units 18. Each of the drive units 18 includes a main beam 20 having drive wheels 22 and 24 rotatably mounted on the opposite ends thereof. Usually, a gearbox 26 is provided for each of the drive wheels 22 and 24 with the gearboxes 26 being driven by an electric motor so that the irrigation system may be propelled through the field about the center pivot structure. Although a center pivot irrigation system 10 is illustrated, the gearbox lubricant fill and drain assembly of this invention may be employed on other mechanized irrigation systems such as a linear move irrigation system, a corner irrigation system, etc.

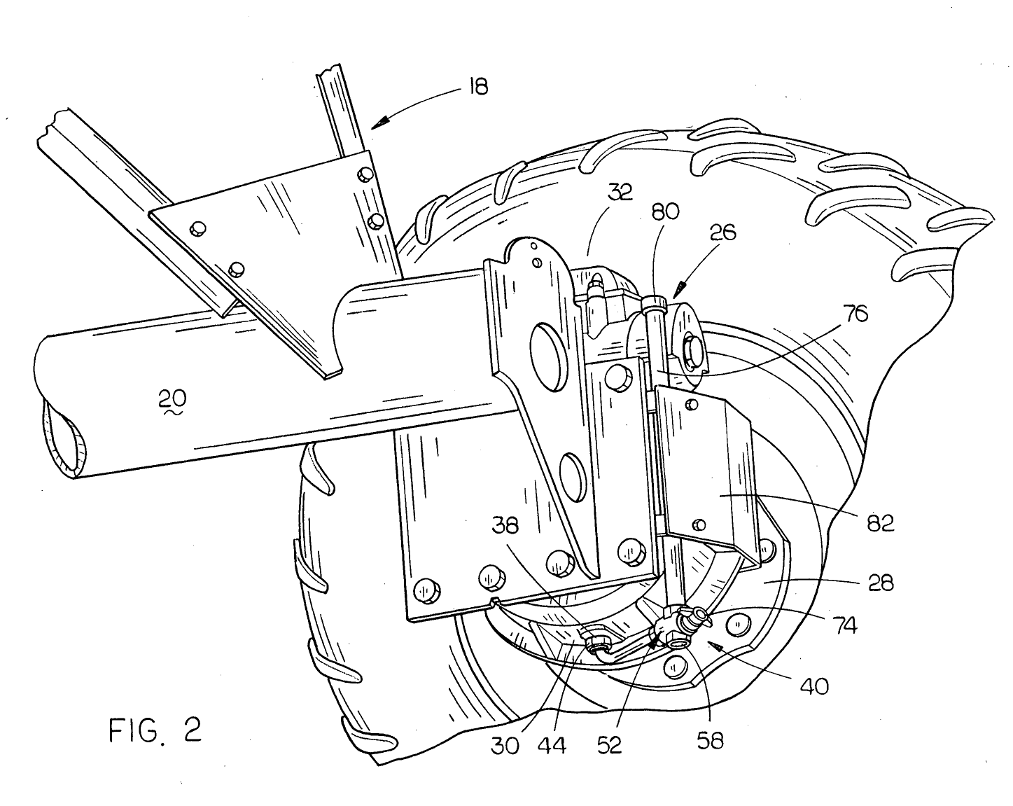

FIG. 2 illustrates a typical gearbox 26 to which the drive wheel hub 28 or the associated drive wheel is attached. The gearbox includes a lower end 30 and an upper end 32. Gearbox 26 includes a selectively closable lubricant fill opening (not shown). Gearbox 26 also includes a drain hole 38 formed therein which is normally closed by a drain plug (not shown).

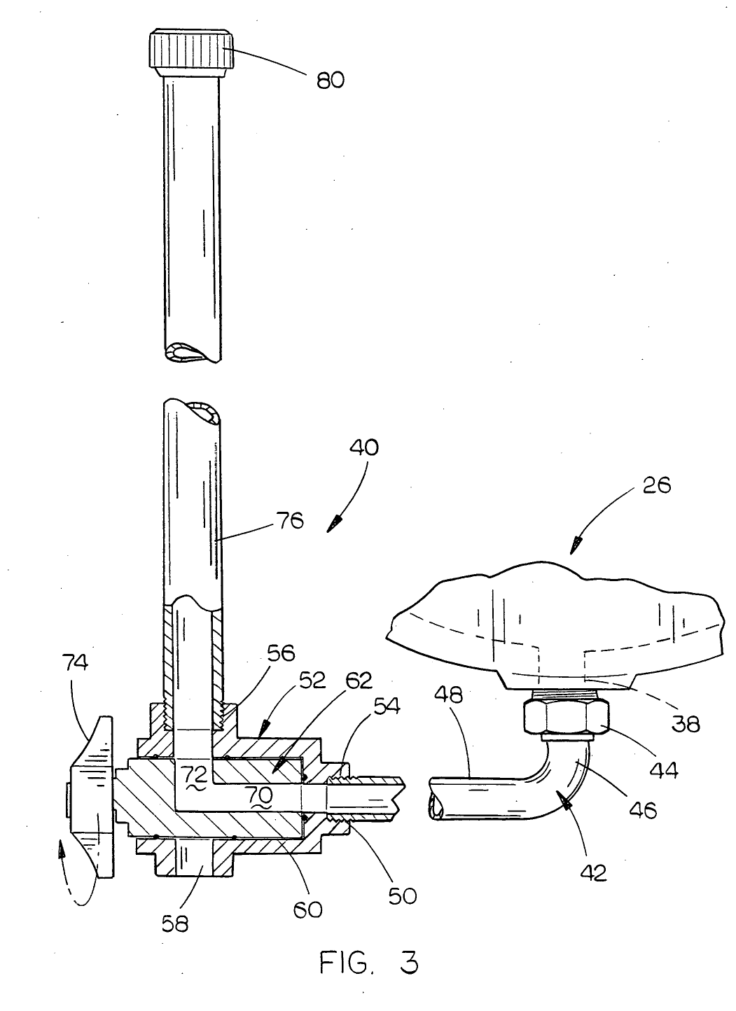

The gearbox fill and drain assembly of this invention is referred to generally by the reference numeral 40. Assembly 40 includes a tube or pipe 42 which has a threaded fitting 44 mounted therein which is threaded into the drain hole or opening 38 after the drain plug has been removed. Pipe 42 includes a vertically disposed pipe portion 46 and a horizontally disposed pipe portion 48 having an externally threaded portion 50. The numeral 52 refers to a valve body having partially threaded openings 54 and 56 and a drain opening 58 formed therein. Although pipe 42 is shown as being threadably connected to valve body 52, pipe 42 could be secured to valve body 52 by other means such as welding or soldering. The valve body 52 has a compartment 60 formed therein, one end of which is open to permit a valve 62 to be selectively rotatably mounted therein. Valve 62 includes a horizontally extending bore or passageway 70 formed therein, the inner end of which communicates with the bore or passageway 72. Passageway 70 communicates with the inner end of opening 54 which receives the end 50 of pipe portion 48. When the valve 62 is in the position of FIG. 3, passageway 72 communicates with opening 56. If the valve 62 is rotated 90° from the FIG. 3 position, the outer end of passageway 72 is sealed by the valve body. If valve 62 is rotated 180° from the position of FIG. 3, passageway 72 will communicate with drain opening 58. Handle 74 is mounted on the outer end of valve 62 to facilitate rotation of valve 62. Valve 62 could be a ball valve if so desired.

The lower end of fill tube 76 is threadably received by threaded opening 56. Although pipe 76 is shown as being threadably secured to valve body 52, it could be secured thereto by other means such as welding or soldering. The upper end of fill tube 76 is positioned at the same level as the fill opening 34 in gearbox 26. An oversized cap 78 is threaded onto the upper end of tube 76.

The instant invention is used as follows. First, a valve 62 is rotated by the handle 74 so that the passageway 72 in valve 62 is not in communication with the opening 56 of valve body 52. The plug which normally closes the drain opening 38 and the gearbox 26 is removed and the fitting 44 is threadably mounted into the drain opening 38. When it is desired to add lubricant to the gearbox 26, the oversize cap 80 is removed from the fill tube 76 and the fill tube 76 is filled with lubricant by any convenient means. The valve 62 is then rotated with respect to valve body 52 so that passageway 72 is in communication with the opening 56. Normally, the fill plug at the upper end of the gearbox 26 will be removed from the gearbox at this time or just prior to the valve being moved to the position just described. Lubricant will flow from the fill tube 76 into the bottom of the gearbox 26 and the lubricant level in the gearbox 26 will rise until it reaches the level of the upper end of the fill tube 80 which is at the same height as the fill opening of the gearbox 26 by positioning the upper end of the fill tube 76 at the same level as the fill opening in the gearbox 26, it is ensured that the gearbox will not be overfilled with lubricant. When the gearbox has been sufficiently filled with lubricant, the valve 62 is rotated so that passageway 72 is no longer in communication with opening 76. The gearbox fill and drain assembly 40 will be left in position on the gearbox and is protected by a suitable shield 82.

When it is desired to drain either lubricant or water from the gearbox 26, valve 62 is rotated so that passageway 72 is in communication with the drain opening 58 in valve body 52 so that either lubricant or water may flow from the interior of the gearbox 26 outwardly through the drain opening 58.

Thus it can be seen that a novel gearbox fill and drain assembly has been provided which may be used to not only fill a gearbox with lubricant but which may also be used to drain water or lubricant from the gearbox. The oversized cap 82 prevents contamination of the upper end of the fill tube 76 by shielding or covering a large part of the upper end of the fill tube 76.

The assembly of this invention permits a convenient method of draining lubricant or water from the interior of the gearbox 26.

Thus, it can be seen that a novel gearbox fill and drain assembly has been provided which accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A lubricant fill and drain assembly for a gearbox mounted on a drive unit of a mechanized irrigation system, the gearbox having upper and lower ends with a lubricant fill hole extending thereinto below the upper end thereof and a lubricant drain hole formed therein at the lower end thereof, comprising:
a fitting mounted in the drain hole of the gearbox;
a first pipe having a first end and a second end;
said first end of said first pipe being fluidly connected to said fitting;
a valve body having a first end, a second end, an upper end and a lower end;
said valve body having a chamber formed therein;
said valve body having a first opening extending into said second end thereof which is in communication with said chamber;
said first opening being in fluid communication with said second end of said first pipe;
said valve body having a second opening extending into said upper end thereof which is in communication with said chamber;
said valve body having a drain opening extending into said lower end thereof which is in communication with said chamber;
a valve selectively rotatably mounted in said chamber of said valve body;
said valve having a horizontally disposed first passageway formed therein which has first and second ends;
said first end of said first passageway being in continuous communication with said first opening in said valve body;
said valve having a second passageway formed therein which extends generally transversely from said second end of said first passageway to the exterior of said valve body;
said valve being selectively rotatably between first, second and third positions;
said second passageway being in fluid communication with said second opening when said valve is in its said first position;
said second passageway being sealed by said valve body when said valve is in its said second position;
said second passageway being in fluid communication with said drain opening when said valve is in its said third position;
a vertically disposed lubricant fill tube having upper and lower ends adapted to receive gearbox lubricant therein;
said lower end of said lubricant fill tube being in fluid communication with said second opening of said valve body;
said upper end of said lubricant fill tube being disposed at a level substantially the same as the fill opening of the gearbox and spaced horizontally therefrom;
and a cap selectively closing said upper end of said lubricant fill tube.

2. The assembly of claim 1 wherein said cap threadably embraces said upper end of said lubricant fill tube and has a diameter substantially greater than the diameter of said lubricant fill tube.

3. The assembly of claim 1 further including a valve handle secured to said valve for selectively rotating said valve with respect to said valve body.

4. The assembly of claim 1 wherein said valve body is positioned below the drain opening in the gearbox and is spaced laterally therefrom.
